(19) United States
(12) Patent Application Publication
(10) Pub. No.: US 2011/0050490 A1
(43) Pub. Date: Mar. 3, 2011

(54) POSITIONING DATA RECEIVER, ERROR CORRECTING DEVICE AND ERROR CORRECTING METHOD

(75) Inventor: Takeshi Matsue, Fussa-shi (JP)

(73) Assignee: CASIO COMPUTER CO., LTD., Tokyo (JP)

(21) Appl. No.: 12/848,373

(22) Filed: Aug. 2, 2010

(30) Foreign Application Priority Data
Aug. 31, 2009 (JP) 2009-199651

(51) Int. Cl. G01S 19/40

(52) U.S. Cl. 342/357.23

(57) ABSTRACT

A positioning data receiver for receiving positioning data transmitted from a positioning satellite, including an error judging unit for judging whether an error is contained in the positioning data on the basis of collation of parity bits contained in the positioning data; and an error correcting unit for determining which bit of the positioning data is an error bit on the basis of the collation of the parity bits and correcting a value of the error bit when it is judged by the error judging unit that an error is contained.

### CROSS-REFERENCE TO RELATED APPLICATIONS

This application is based upon and claims the benefit of priority from the prior Japanese Patent Application No. 2009-199651, filed on Aug. 31, 2009, and the entire contents of which are incorporated herein by reference.

### BACKGROUND OF THE INVENTION

1. Field of the Invention

The present invention relates to a positioning data receiver for receiving data for positioning transmitted from a positioning satellite, an error correcting device for performing error correction of data for positioning and an error correcting method.

2. Description of the Related Art

A GPS (Global Positioning System) receiver for receiving a navigation message and a positioning code from a GPS satellite and measuring the present position has been hitherto known. The navigation message contains orbit information of the satellite, time information, various kinds of correction information, etc., and it is constructed by assembling twenty five main frames each of which comprises 1500 bits. The main frame of 1500 bits is divided into five sub frames each of which comprises 300 bits, and the sub frame is divided into ten words each of which comprises 30 bits.

With respect to a general GPS receiver, when the navigation message as described above is received, a parity check as to whether any bit error exists in the received navigation message is executed by using a parity bit contained in the navigation message. 6 bits are contained as the parity bit in the word of 30 bits.

This technique is described in JP-A-2000-056007, JP-A-2001-228233, JP-A-2003-194910, etc.

It takes about 12.5 minutes to transmit all the data of the navigation message. All the data of the navigation message are not required to measure the present position and settle the present time, however, there generally occurs such a situation that a bit error is detected when a navigation message is received and necessary data cannot be obtained. In this case, if the data in which a bit error is detected is discarded and thus this same data is received again when it is transmitted, it takes a longer time to obtain the data.

### SUMMARY OF THE INVENTION

An object of the present invention is to provide a positioning data receiver, an error correcting device and an error correcting method that can quickly obtain correct positioning data (for example, navigation message) through reception of this data even when a part of the positioning data contains a bit error.

In order to attain the above object, according to the present invention, a positioning data receiver for receiving positioning data transmitted from a positioning satellite, comprising: error judging means for judging whether an error is contained in the positioning data on the basis of collation of parity bits contained in the positioning data; and error correcting means for determining which bit of the positioning data is an error bit on the basis of the collation of the parity bits and correcting a value of the error bit when it is judged by the error judging means that an error is contained.

Furthermore, according to the present invention, an error correcting device for performing error correcting on positioning data transmitted from a positioning satellite, comprising: error judging means for judging whether an error is contained in the positioning data on the basis of collation of parity bits contained in the positioning data; and error correcting means for determining which bit of the positioning data is an error bit on the basis of the collation of the parity bits and correcting a value of the error bit when it is judged by the error judging means that an error is contained.

Still furthermore, according to the present invention, an error correcting method for performing error correcting on positioning data received from a positioning satellite, comprising: an error judging step for judging whether an error is contained in the positioning data on the basis of collation of parity bits contained in the positioning data; and an error correcting step for determining which bit of the positioning data is an error bit on the basis of the collation of the parity bits and correcting a value of the error bit when it is judged in the error judging step that an error is contained.

### BRIEF DESCRIPTION OF THE DRAWINGS

FIG. 1 is a block diagram showing the overall construction of a GPS receiver according to a first embodiment of the present invention;

FIG. 2 is a block diagram showing the detailed construction of a navigation message signal processor;

FIG. 3 is a data chart showing the data construction of a part of a navigation message;

FIG. 4 is a table showing a parity comparison result when no error bit exists in a word;

FIG. 5 is a table showing the relationship between a parity comparison result and an error bit position when one bit error is contained in a word;

FIG. 6 is a flowchart showing an operation procedure of a navigation message signal processor;

FIG. 7 is a graph showing effectiveness of the navigation message signal processor; and

FIG. 8 is a block diagram showing the overall construction of a GPS receiver according to a second embodiment of the present invention.

### DETAILED DESCRIPTION OF THE PREFERRED EMBODIMENTS

Preferred embodiments according to the present invention will be described hereunder with reference to the accompanying drawings.

### First Embodiment

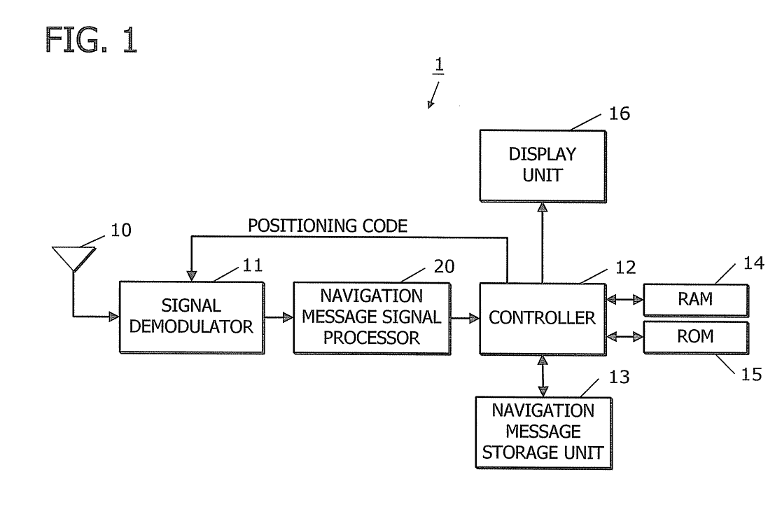

FIG. 1 is a block diagram showing the overall construction of a GPS receiver 1 as a first embodiment of a positioning data receiver according to the present invention.

The GPS receiver 1 of this embodiment receives a navigation message (positioning data) and a positioning code (for example, CA code) from a GPS (Global Positioning System) satellite as a positioning satellite, and executes positioning calculation on the basis of these data to calculate the present position (longitude, latitude, altitude, etc.). As shown in FIG. 1, the GPS receiver 1 comprises an antenna 10 for receiving electrical waves from the GPS satellite, a signal demodulator 11 for demodulating received electrical waves to obtain a signal of the navigation message, a navigation message signal processor 20 for executing parity check and error correction on the signal of the demodulated navigation message, a navigation message storing unit 13 for storing the received navigation message, a controller 12 which contains CPU (Central Processing Unit) and executes the operation control of the respective parts and various kinds of data processing, ROM (Read Only Memory) 15 in which a control program to be executed by CPU of the controller 12 and control data are stored, RAM (Random Access Memory) 14 for supplying a working memory space to CPU of the controller 12, a display unit 16 for receiving display data from the controller 12 and displaying and outputting, for example, information of the present position, etc.

In the positioning processing of measuring the present position, when a navigation message has not been received yet or it is necessary to update the navigation message, the controller 12 operates the signal demodulator 11 and the navigation message signal processor 20 to receive the navigation message. The received navigation message is written and stored into a storage unit 13. Here, when the navigation message is obtained, a positioning code is extracted from a transmission signal from the GPS satellite. Furthermore, a predetermined positioning calculation is executed on the basis of reception times of positioning codes from plural GPS satellites and various kinds of data in the navigation messages to calculate the present position.

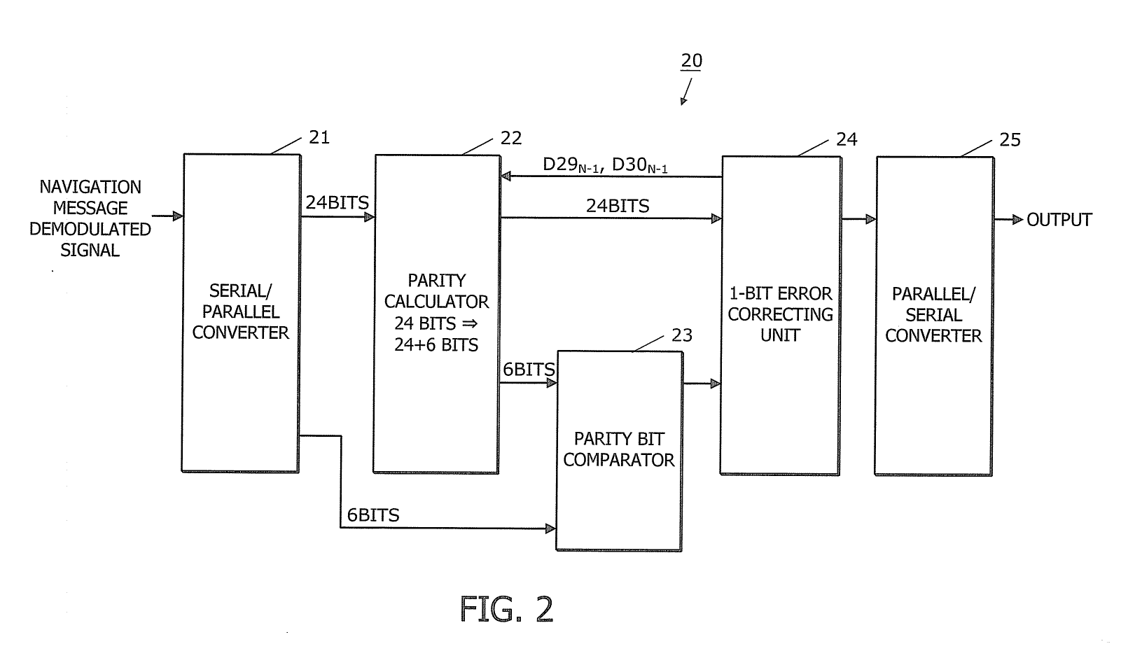

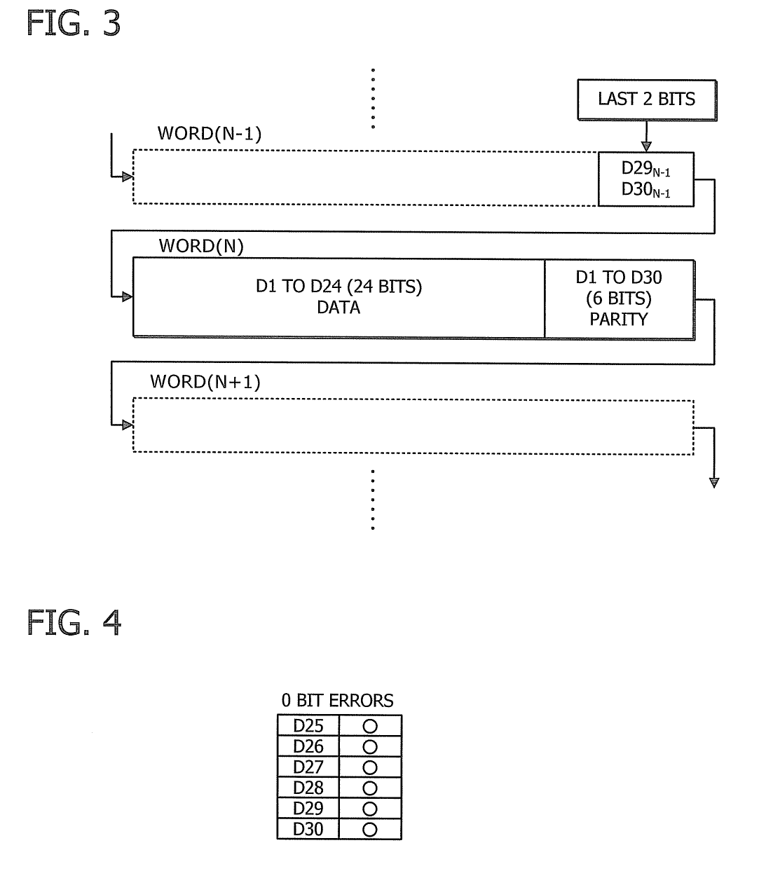

FIG. 2 is a block diagram showing the detailed construction of the navigation message signal processor 20 of FIG. 1, and FIG. 3 is a data chart representing the data construction of a part of the navigation message.

As shown in FIG. 2, the navigation message signal processor 20 comprises a serial/parallel converter 21, a parity calculator 22, a parity bit comparator 23, a 1-bit error correcting unit 24, a parallel/serial converter 25, etc.

The navigation message contains orbit information of the GPS satellite, time information, various kinds of correcting information, etc., and it is constructed by assembling twenty five main frames each of which comprises 1500 bits. The main frame is divided into five sub frames each of which comprises 300 bits, and the sub frame is divided into ten words as units of divisional data each of which comprises 30 bits as shown in FIG. 3.

With respect to the word of 30 bits, 24 bits from the head thereof are allocated to a data bit representing the content of a navigation message and the remaining 6 bits are allocated to a parity bit for judging error of the word concerned.

The serial/parallel converter 21 of FIG. 2 converts the demodulated signal of the navigation message from serial data to parallel data every word of 30 bits, and outputs the converted parallel data to the rear stage. The serial/parallel converter 21 outputs the data of 24 bits from the head of the word to the parity calculator 22, and outputs the parity bit of the remaining 6 bits to the parity comparator 23.

The parity calculator 22 is a logical circuit for calculating 6-bit parities P25 to P30 for a word as a processing target on the basis of 24-bit data as a processing target sent from the serial/parallel converter 21 and values of 2-bit D29_{N-1}, D30_{N-1} at the rear end of a word which was process just before. The calculated parities P25 to P30 are outputted to the parity bit comparator 23, and also the 24-bit data supplied from the front stage are directly outputted to the 1-bit error correcting unit 24.

The calculation of the parities P25 to P30 executed by the parity calculator 22 is executed according to the following expressions (1). Here, 24 bits at the head of the word as the processing target are represented by D1 to D24, and 2 bits at the rear end of the word processed just before are represented by D29_{N-1}, D30_{N-1}. A plus symbol in a circle represents exclusive OR.

$$\begin{matrix}\{ \begin{matrix}d 1 , & d 1 , & … & d 24 \} = D {30}_{N - 1} ⊕ \{ \begin{matrix}D 1 , & D 2 , & … & D 24 \}\end{matrix}\end{matrix} \\ P 25 = D {29}_{N - 1} ⊕ d 1 ⊕ d 2 ⊕ d 3 ⊕ d 5 ⊕ d 6 ⊕ d 10 ⊕ d 11 ⊕ d 12 ⊕ \\ d 13 ⊕ d 14 ⊕ d 17 ⊕ d 18 ⊕ d 20 ⊕ d 23 \\ P 26 = D {30}_{N - 1} ⊕ d 2 ⊕ d 3 ⊕ d 4 ⊕ d 6 ⊕ d 7 ⊕ d 11 ⊕ d 12 ⊕ d 13 ⊕ \\ d 14 ⊕ d 15 ⊕ d 18 ⊕ d 19 ⊕ d 21 ⊕ d 24 \\ P 27 = D {29}_{N - 1} ⊕ d 1 ⊕ d 3 ⊕ d 4 ⊕ d 5 ⊕ d 7 ⊕ d 8 ⊕ d 12 ⊕ d 13 ⊕ \\ d 14 ⊕ d 15 ⊕ d 16 ⊕ d 19 ⊕ d 20 ⊕ d 22 \\ P 28 = D {30}_{N - 1} ⊕ d 2 ⊕ d 4 ⊕ d 5 ⊕ d 6 ⊕ d 8 ⊕ d 9 ⊕ d 13 ⊕ d 14 ⊕ \\ d 15 ⊕ d 16 ⊕ d 17 ⊕ d 20 ⊕ d 21 ⊕ d 23 \\ P 29 = D {30}_{N - 1} ⊕ d 1 ⊕ d 3 ⊕ d 5 ⊕ d 6 ⊕ d 7 ⊕ d 9 ⊕ d 10 ⊕ d 14 ⊕ \\ d 15 ⊕ d 16 ⊕ d 17 ⊕ d 18 ⊕ d 21 ⊕ d 22 ⊕ d 24 \\ P 30 = {D29}_{N - 1} ⊕ d 3 ⊕ d 5 ⊕ d 6 ⊕ d 8 ⊕ d 9 ⊕ d 10 ⊕ d 11 ⊕ d 13 ⊕ \\ d 15 ⊕ d 19 ⊕ d 22 ⊕ d 23 ⊕ d 24\end{matrix} ) \qquad ( 1 )$$

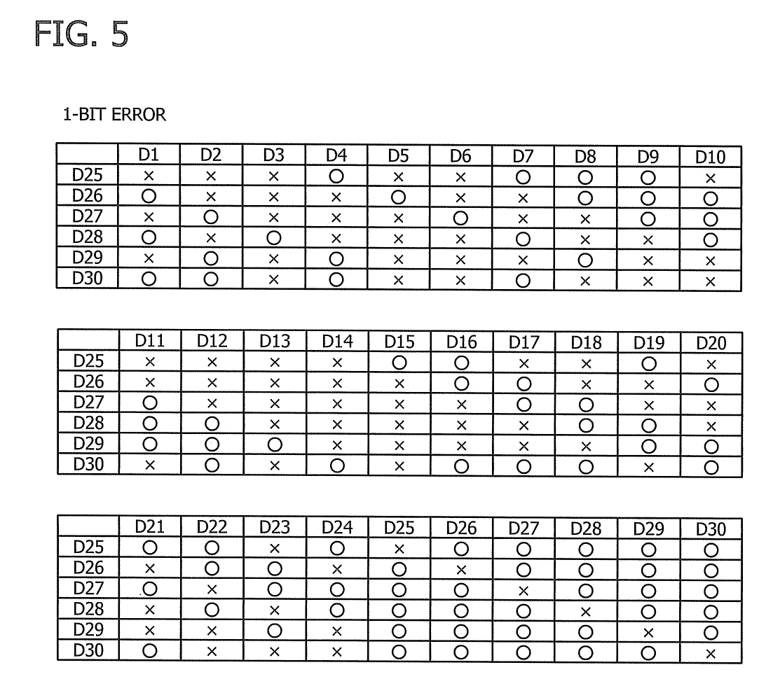

FIG. 4 is a table showing a parity comparison result when no error bit exits in a word, and FIG. 5 is a table showing the relationship between a parity comparison result and the position of an error bit when a 1-bit error is contained in a word. In the tables of FIGS. 4 and 5, when the parity bits D25 to D30 in the word are coincident with the calculated values of the parities P25 to P30, “◯” is filled, and when they are not coincident, “X” is filled. The positions of the error bits are represented by “D1 to D30” described on the headline of the table of FIG. 5.

The parity calculating expressions described above are the same as the parity calculation executed at a source of generating the navigation message. Accordingly, when no bit error is contained in a processing target word, the calculated parities P25 to P30 and the parity bits D25 to D30 in the word are wholly coincident with one another as shown in FIG. 4.

When 1-bit error is contained in a word, as shown in FIG. 5, the calculated parities P25 to P30 and the parity bits D25 to D30 in the word are not coincident with one another by only an odd number of bits. Furthermore, in this case, a pattern of coincidence/non-coincidence of the parity bits D25 to D30 is varied in accordance with the position of the error bit. Therefore, when 1-bit error is contained in the word, it can be identified on the basis of the pattern of coincidence/non-coincidence of the parity bits D25 to D30 which bit of the 30 bits D1 to D30 of the word is an error.

According to the parity bits D25 to D30, as not described in detail, when an error within 3 bits is contained in the word, it can be detected that some parity bit of the parity bits D25 to D30 is not coincident and thus an error is contained in the word. Furthermore, when 1-bit error is contained in the word, an odd number of bits out of the parity bits D25 to D30 are not coincident, and when 2-bit error is contained, an even number of bits out of the parity bits D25 to D30 are not coincident. Accordingly, when an error within 2 bits is contained in the word, 1-bit error and 2-bit error can be discriminated from each other.

The parity bit comparator 23 of FIG. 2 has a plurality of comparators for comparing 6-bit parity bits D25 to D30 sent from the serial/parallel converter 21 with 6-bit parities P25 to P30 sent from the parity calculator 22 respectively, and send a 6-bit comparison result signal outputted from these comparators to the 1-bit error correcting unit 24.

The 1-bit error correcting unit 24 has a logical judgment circuit for judging an error on the basis of the comparison result of the parity bits D25 to D30, a decoder circuit for determining an error bit from the comparison result of the parity bits D25 to D30 in the case of 1-bit error, etc. The logical judgment circuit receives a 6-bit comparison result signal supplied from the parity bit comparator 23. When all the bits are coincident, no error is judged. When an odd number of bits are not coincident, 1-bit error is judged. When an even number of bits are not coincident, 2-bit or more error is judged. Actually, even when all the 6-bit parity bits D25 to D30 are coincident, 4-bit or more error may possibly be contained in the word, and even when an odd number of bits out of the parity bits D25 to D30 are not coincident, 3-bit or 4-bit or more error may possibly be contained in the word.

The 1-bit error correcting unit 24 directly outputs all the words sent from the front stage to the rear stage when no error is judged by the logical judgment circuit. Furthermore, when 1-bit error is judged, the 1-bit error correcting unit 24 first inputs a coincidence/non-coincidence signal of the parity bits D25 to D30 to the decoder circuit, and determines the positions of a error bit shown in the table of FIG. 5. Then, the 1-bit error correcting unit 24 inverts the value (error correction) of the error bit position for the word sent from the front stage and then outputs the word to the rear stage. Furthermore, when 2-bit or more error is judged, for example, the 1-bit error correcting unit 24 discards the word under the processing, and executes the processing corresponding to the specification of the data error, for example, delivers data representing a data error to the rear stage or the like.

Furthermore, the 1-bit error correcting unit 24 outputs to the parity calculator 22 the values of rear-end 2-bit D29, D30 necessary for the parity calculation in the processing for the next word when no bit-error is judged or when 1-bit error is judged and thus the error correction is executed.

The parallel/serial converter 25 converts the data of the word sent from the 1-bit error correcting unit 24 to serial data, and outputs the thus-converted serial data to the controller 12.

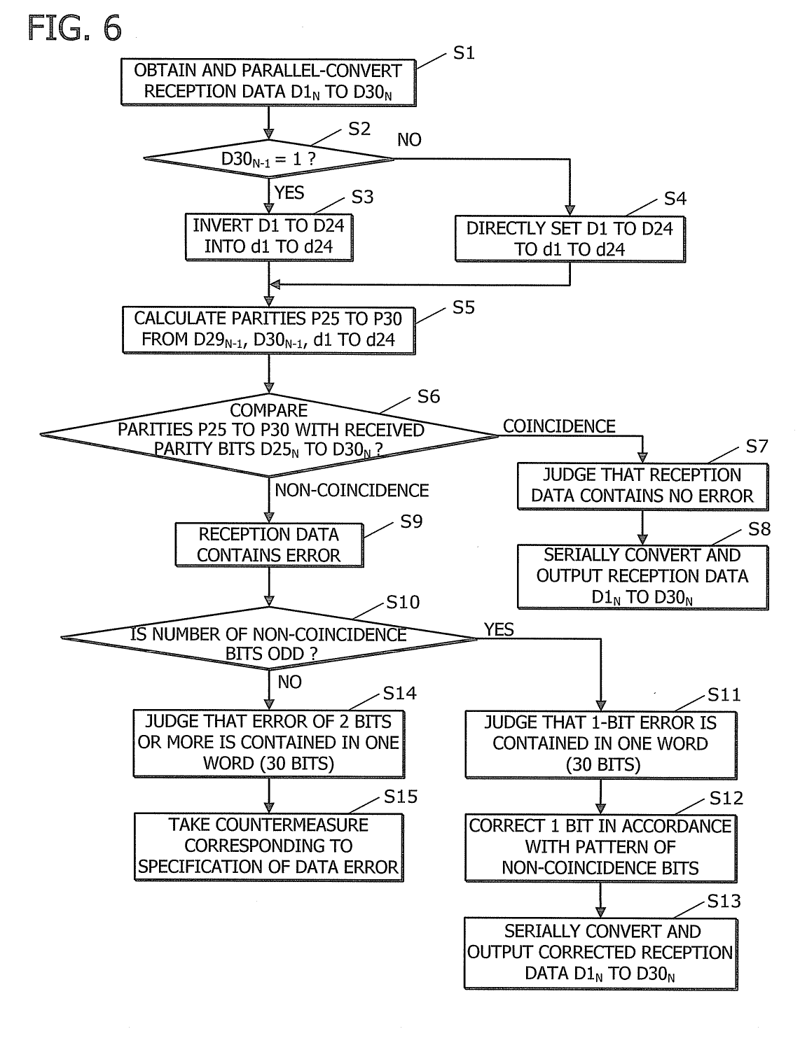

FIG. 6 is a flowchart showing the operation procedure of the navigation message signal processor 20.

A series of operation procedure of the navigation message signal processor 20 is executed according to the flowchart of FIG. 6. That is, first, when reception data of one word (30 bits D1_{N} to D30_{N}) is acquired, the serial/parallel converter 21 converts this data to parallel data (step S1).

Subsequently, the parity calculator 22 determines whether the value of 1-bit D30_{N-1} at the rear end of an (N−1)-th word which has been processed just before is equal to “1”. If the value is equal to “1”, the parity calculator 22 inverts the values of 24 bits D1 to D24 supplied from the serial/parallel converter 21. That is, when the value is equal to “1”, it is inverted to “0”. When the value is equal to “0”, it is inverted to “1”. Then, the inverted values are set to the values of 24 bits d1 to d24 for parity calculation (step S3).

On the other hand, when the value of the rear-end 1-bit D30_{N-1} is equal to “0”, the values of the 24 bits D1 to D24 are directly set as the values of 24 bits d1 to d24 for parity calculation (step S4).

When the 24 bits d1 to d24 for parity calculation are settled, the parity calculator 22 executes the logical calculation on the above expression (1) on the basis of the 24 bits d1 to d24 and the values of the rear-end 2 bits D29_{N-1}, D30_{N-1} of the (N−1)-th word which was processed just before, thereby calculating the parities P25 to P30 (step S5).

When the parities P25 to P30 are calculated, the parity bit comparator 23 collates the parities P25 to P30 with the parity bits D25 to D30 of the word which are sent from the serial/parallel converter 21 and is being currently processed, thereby performing the parity check (step S6). 6-bit data representing coincidence/non-coincidence representing the result of the parity check and the values of the parity bits D25 to D30 are transmitted to the 1-bit error correcting unit 24.

When all of 6-bit data are coincident as the result of the parity check, the logical judgment circuit of the 1-bit error correcting unit 24 determines that no error exists in the reception data (step S7), so that the data D1 to D30 sent from the parity calculator 22 and the parity bit comparator 23 are directly sent to the parallel/serial converter 25. Thereafter, the parallel/serial converter 25 converts these data D1 to D30 to serial data, and outputs the serial data to the circuit at the rear stage (step S8).

On the other hand, when the result of the parity check of the step S6 indicates “non-coincidence”, the logical judgment circuit of the 1-bit error correcting unit 24 determines that an error exists in the reception data (step S9). Subsequently, it is determined whether the number of “non-coincidence” bits is odd or not (step S10). When the number is odd, it is determined that error of 1 bit exists in one word (step S11). On the other hand, when the number of “non-coincidence” bits is even, it is determined that error of 2 bits or more exists in one word (step S14).

When the 1-bit error is identified as the identification result of the step S10, a signal of 6 bits representing the result of the parity check is sent to the decoder circuit of the 1-bit error correcting unit 24, and the position of the error bit is determined on the basis of the pattern shown in the table of FIG. 5. Then, the 1-bit error correcting unit 24 inverts and corrects the value of this error bit (step S12). The corrected data D1 to D30 are converted to serial data by the parallel/serial converter 25, and then outputted to the circuit at the rear stage (step S13).

When an error of 2 bits or more exists as an identification result of the step S10, the 1-bit error correcting unit 24 executes the processing corresponding to the specification of the data error, for example, generates data representing a data error and outputs the data to the rear stage (step S15), whereby it is sent to the controller 12 at the rear stage that the word being currently processed has a data error.

According to the GPS receiver 1 of this embodiment, when many words constituting a navigation message are received, the parity check of each word is executed in the navigation message signal processor 20, and the checked data are sent to the controller 12 and stored into the navigation message storage unit 13.

Furthermore, when the number of “non-coincidence” bits out of the parity bits D25 to D30 is odd and thus 1-bit error is estimated under the parity check, 1-bit error is judged. Therefore, as shown in FIG. 5, the value of the error bit corresponding to the “coincidence/non-coincidence” pattern of the parity check result are corrected. Accordingly, under such a condition that a bit error slightly occurs, the bit error is accurately corrected, and the corrected data are successively stored into the navigation message storage unit 13 by the controller 12. Accordingly, the processing of retrying to receive the data corresponding to the bit-error portion can be omitted, and thus the necessary data in the navigation message can be quickly obtained.

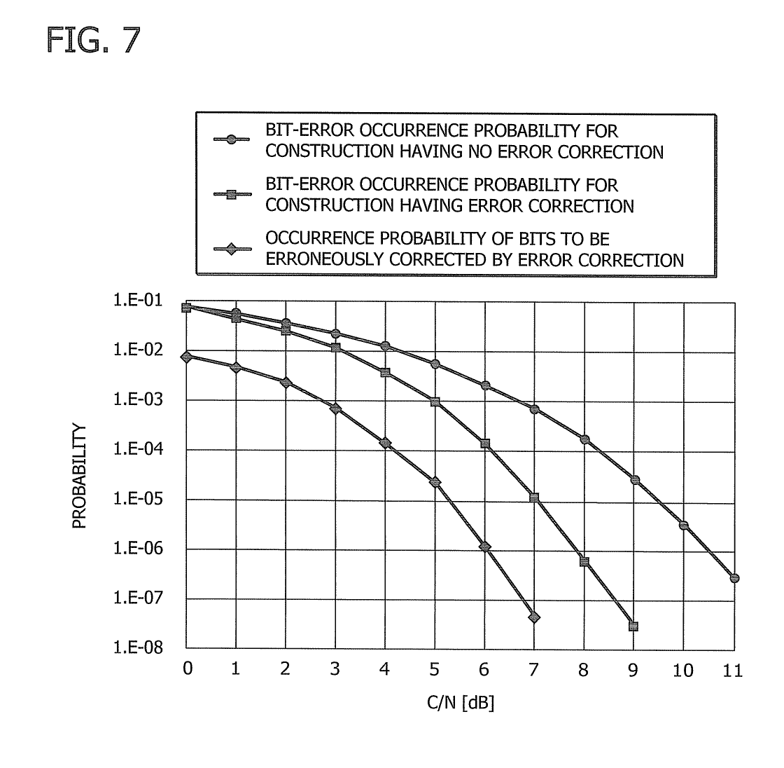

FIG. 7 is a graph showing effectiveness of the navigation message signal processor 20. This graph shows a simulation result of data identification when noises of 0 dB to 11 dB in CN ratio (carrier-to-noise ratio) are randomly added to the signal of a 30-bit word. A “black circle” plot line represents a bit-error occurrence probability when plural words are received in a construction that error correction is not executed, a “rectangle” plot line represents a bit-error occurrence probability when plural words are received in a construction that error check and error correction are executed by the navigation message signal processor 20, and a “lozenge” plot line represents an occurrence probability of bits which are erroneously corrected by the navigation message signal processor 20 when plural words are received.

In the error correcting processing of the navigation message signal processor 20, there is a probability that the following erroneous correction may be theoretically executed. That is, when an error of 3 bits or more exists in one word and the result of the parity check indicates “non-coincidence” of an odd number of bits, the navigation message signal processor 20 judges 1-bit error, and the correct bit is erroneously corrected.

However, as shown in the “lozenge” plot line of FIG. 7, it is found from the simulation result that the occurrence probability of the erroneous correction described above is very small. For example, in the case of the CN ratio of “7 dB” at which bit error occurs slightly, the occurrence probability of the bit error is reduced to about 1/100 by executing the error correction of this embodiment, and the occurrence probability of bits to be erroneously corrected is reduced to 10⁻⁷ or less, that is, reduced to a negligible level.

Furthermore, even in the case of the CN ratio of “3 dB” at which bit error occurs frequently, the occurrence probability of the bit error can be reduced by a fixed amount through the error correction. Furthermore, the occurrence probability of bits to be erroneously corrected is kept to 10⁻³ or less.

That is, by executing the error correction of this embodiment, the bit error is more clearly reduced as compared with the case where the error correction is not executed. Furthermore, the probability that error bit is increased due to erroneous correction is small and the influence thereof is smaller as compared with the effect of the error correction.

From the foregoing reason, it is apparent that the GPS receiver 1 of this embodiment has an effect of quickly obtaining necessary data in a navigation message by the error correction even such a condition that bit error occurs slightly, and the influence of the erroneous correction hardly occurs.

### Second Embodiment

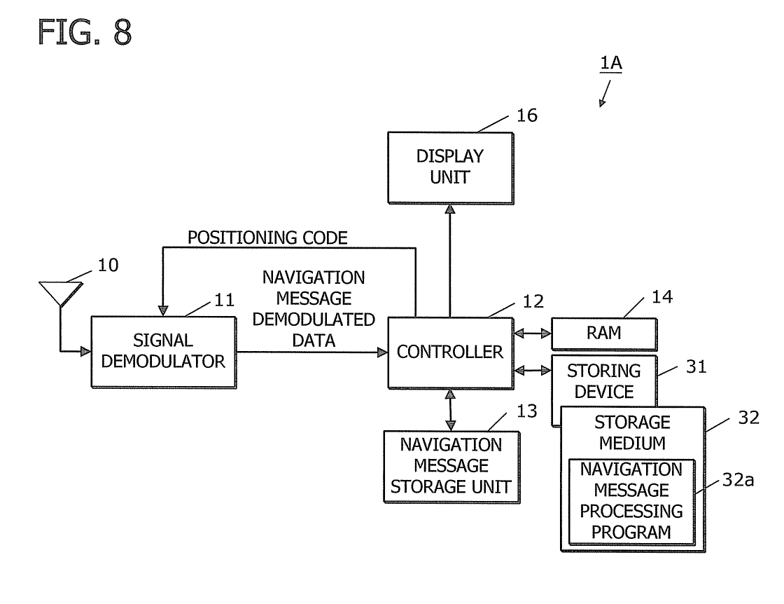

FIG. 8 is a block diagram showing the overall construction of the GPS receiver 1A of a second embodiment.

The GPS receiver 1A of the second embodiment is configured so that the construction of the navigation message signal processor 20 of the first embodiment is implemented with software executed by CPU of the controller 12. The same construction constituents as the first embodiment are represented by the same reference numerals, and the description thereof is omitted.

The GPS receiver 1A of this embodiment comprises an antenna 10, a signal decoder 11, a controller 12 as a computer, a navigation message storage unit 13, RAM 14, a display unit 16, and a storing device 31 which is configured so that data can be read out from the storing device 31 by CPU of the controller 12.

A navigation message processing program 32a for implementing the construction of the navigation message signal processor 20 shown in FIG. 2 by software is stored in a storage medium 32 of the storing device 31. The navigation message processing program 32a may be allowed to be stored in ROM as a computer-readable medium, or stored in a non-volatile memory such as a flash memory or the like or a portable recording medium such as CD-ROM or the like. Furthermore, carrier wave may be applied as a medium for supplying the data of the program according to the present invention through a communication line.

In the GPS receiver 1A of the second embodiment, CPU of the controller 12 executes the navigation message processing program 32a, whereby the respective constituent elements of FIG. 2 (the serial/parallel converter 21, the parity calculator 22, the parity bit comparator 23, the 1-bit error correcting unit 24, the parallel/serial converter 25) are generated as functional modules in RAM 14. Furthermore, the processing of respective steps S1 to S15 shown in the flowchart of FIG. 6 is executed on demodulated data (reception data) supplied from the signal demodulator 11 by these functional modules.

As described above, according to the GPS receiver 1A and the navigation message processing program 32a of the second embodiment, as in the case of the first embodiment, there can be obtained an effect that necessary data in the navigation message can be quickly obtained by executing the error correction even when a slight error is contained in the navigation message.

The present invention is not limited to the first and second embodiments, and various modifications may be made. For example, in the first and second embodiments, the navigation message transmitted from the GPS satellite is adopted as the positioning data. However, when positioning data having a similar parity bit is transmitted from another positioning satellite, the present invention may be likewise applied to a construction for receiving this positioning data.

Furthermore, when error correction of a navigation message is executed by the software of the second embodiment, demodulation data sent from the signal demodulator 11 are subjected to parity check and error correcting on a real-time basis, but the demodulation data may be temporarily accumulated in a buffer and then subjected to the parity check and the error correction by batch processing.

The detailed portions of the embodiment such as the respective constituent elements of the GPS receiver, the method of the parity calculation, etc. may be properly modified without departing from the subject matter of the present invention.

What is claimed is:

1. A positioning data receiver for receiving positioning data transmitted from a positioning satellite, comprising:
error judging means for judging whether an error is contained in the positioning data on the basis of collation of parity bits contained in the positioning data; and
error correcting means for determining which bit of the positioning data is an error bit on the basis of the collation of the parity bits and correcting a value of the error bit when it is judged by the error judging means that an error is contained.

2. The positioning data receiver according to claim 1, wherein the parity bits is defined so that when a 1-bit error is contained in a unit of divisional data of the positioning data, it can be determined which bit of the divisional data is an error bit, and the error correcting means executes error correction on a 1-bit error in the divisional data which is determined as an error bit on the basis of the collation of the parity bits.

3. The positioning data receiver according to claim 2, wherein the parity bits is defined so that when an error within 3 bits is contained in the unit of divisional data of the positioning data, it is detectable that an error bit is contained in the divisional data, and also when an error within 2 bits is contained in the divisional data, it can be determined whether a 1-bit error or 2-bit errors is contained, and the error correcting means executes the error correction on the 1-bit error when an error is determined as a 1-bit error if an error within 2 bits is contained in the divisional data on the basis of the collation of the parity bits.

4. The positioning data receiver according to claim 1, wherein the positioning data is a navigation message transmitted from a GPS satellite, and the unit of the divisional data is data of totally 30 bits comprising data bits of 24 bits and the parity bits of 6 bits.

5. An error correcting device for performing error correcting on positioning data transmitted from a positioning satellite, comprising:
error judging means for judging whether an error is contained in the positioning data on the basis of collation of parity bits contained in the positioning data; and
error correcting means for determining which bit of the positioning data is an error bit on the basis of the collation of the parity bits and correcting a value of the error bit when it is judged by the error judging means that an error is contained.

6. An error correcting method for performing error correcting on positioning data received from a positioning satellite, comprising:
an error judging step for judging whether an error is contained in the positioning data on the basis of collation of parity bits contained in the positioning data; and
an error correcting step for determining which bit of the positioning data is an error bit on the basis of the collation of the parity bits and correcting a value of the error bit when it is judged in the error judging step that an error is contained.
